(19) United States
(12) Patent Application Publication
(10) Pub. No.: US 2010/0038360 A1
(43) Pub. Date: Feb. 18, 2010

(54) COLLAPSIBLE CANISTER FOR PREVENTING ANIMALS FROM RETRIEVING CONTENTS THEREFROM WHEN THE CANISTER IS IN A NON-COLLAPSED CONFIGURATION

(76) Inventor: Scott McDonnell, Albany, NY (US)

Correspondence Address: SCHMEISER, OLSEN & WATTS, 22 CENTURY HILL DRIVE, SUITE 302, LATHAM, NY, 12110, US

(21) Appl. No.: 12/193,464

(22) Filed: Aug. 18, 2008

(51) Int. Cl. B65D 8/04; B65D 25/00; B65D 73/00; A01K 29/00; B65D 8/14

(52) U.S. Cl. 220/4.28; 220/730; 220/666; 206/457; 119/712

(57) ABSTRACT

Provided is an animal-proof canister comprising a plurality of interlocking portions, wherein the portions may be disassembled rendering the canister in a collapsed configuration or wherein the portions may be assembled rendering the canister in a non-collapsed configuration. A corresponding method of preventing animals from retrieving contents from a collapsible canister is also provided.

### BACKGROUND OF THE INVENTION

1. Technical Field

This invention relates generally to an animal-proof canister. More particularly, this invention provides an animal-proof canister apparatus, the canister apparatus having at least a collapsed configuration and a non-collapsed configuration. A corresponding method of preventing animals from retrieving contents from the collapsible canister apparatus when in a non-collapsed configuration is also provided.

2. Related Art

Animals, such as bears, raccoons, squirrels, chipmunks, monkeys, birds, and other creatures, are often found within the vicinity of humans, especially when those humans have ventured into outdoor wilderness environments. It is not uncommon for such animals, whether out of a drive created by hunger or out of pure curiosity, to tamper with and/or consume contents and belongings of nearby humans. Hence, containers have been provided to hinder and prevent tampering and/or access, by animals, of the contents stored within the containers. However, known container design configurations, while capacious enough to store contents, often become cumbersome and needlessly bulky once the contents have been depleted or removed from the container volume. Moreover, known container designs are also deficient because animals, often bears in particular, still are able to penetrate and/or break open the container, thereby rendering the contents undesirably accessible. Accordingly, there is a need for an improved animal-proof canister.

### SUMMARY OF THE INVENTION

A first aspect of the present invention provides an animal-proof canister comprising: a separably joinable segmented body, the separably joinable segmented body having a first collapsed configuration, wherein a plurality of separable segmented body portions of the separably joinable body are not joined together being separately positioned in a nested more compact stacked body arrangement, and a second non-collapsed configuration, wherein all separably joinable segmented body portions of the separably joinable segmented body are separably joined together, such that, when in a second non-collapsed configuration, the separably joinable segmented body has at least one opening; and at least one separably joinable lid, the at least one separably joinable lid configured to separably and securely connect to the separably joinable segmented body rendering a completed non-collapsed canister configuration in a manner forming a separably joined and completed non-collapsed canister having an interior volume, the interior volume of the completed non-collapsed canister being readily accessible by humans through disconnection and removal of the at least one separably joinable lid, but inaccessible to non-human animals because of the material strength and structural dimension of the completed non-collapsed canister configuration of the separably joined and completed non-collapsed canister, and the inability of non-human animals to disconnect the at least one separately joinable lid from the separably joinable segmented body.

A second aspect of the present invention provides a collapsible container for preventing animals from retrieving contents therefrom when the collapsible container is in a non-collapsed configuration, the collapsible container comprising: a plurality of interlocking segmented portions, wherein each of the plurality of interlocking segmented portions is structurally configured so that, when the plurality of interlocking segmented portions is fully disassembled and non-interlocked, each of the plurality of interlocking segmented portions is positionable in a stacked arrangement, so that each of the plurality of interlocking segmented portions resides in a nested more compact arrangement with respect to at least one other interlocking segmented portion of the plurality of interlocking segmented portions; wherein, when the plurality of interlocking segmented portions is fully structurally assembled and completely interlocked, each of the plurality of interlocking segmented portions is interlocked to at least two other interlocking segmented portions of the plurality of interlocking portions, in a manner such that the completely interlocked and fully assembled structural organization of interlocking segmented portions constitutes a container having a sealed interior volume; and further wherein at least one of the interlocking segmented portions of the plurality of interlocking segmented portions is removably joinable to at least two other interlocking segmented portions of the plurality of interlocking segmented portions, in a manner so as to operably facilitate an opening up and purposefully partial disassembly of the container having an interior volume, so that a human user can access the interior volume, and so that a non-human animal can not operably facilitate the opening up and purposefully partial disassembly of the container having an interior, in a manner that the container remains sealed and the interior volume is operably inaccessible to a non-human animal.

A third aspect of the present invention provides a method of preventing animals from retrieving contents from a collapsible canister, the method comprising: providing an animal-proof canister including: a plurality of interlocking segmented portions, wherein each of the plurality of interlocking segmented portions is structurally configured so that, when the plurality of interlocking segmented portions is fully disassembled and non-interlocked, each of the plurality of interlocking segmented portions is positionable in a stacked arrangement, so that each of the plurality of interlocking segmented portions resides in a nested more compact arrangement with respect to at least one other interlocking segmented portion of the plurality of interlocking segmented portions; assembling a group of the plurality of interlocking segmented portions, by interlocking each interlocking segmented portion of the group of the plurality of interlocking segmented portions to partially form an animal-proof canister, the partially-formed animal-proof canister having an opening formed by at least two interlocked interlocking segmented portions, the opening constituting an aperture into an interior volume of the partially-formed animal-proof canister; inserting contents through the opening and into the interior volume of the partially-formed animal-proof canister; and fully assembling and completely forming the animal-proof canister by interlocking at least one other interlocking segmented portion to the at least two interlocked interlocking segmented portions forming the opening of the partially-formed animal-proof canister, thereby closing the aperture and sealing the contents into the interior volume of the fully assembled and completely formed animal-proof canister; wherein the animal-proof canister is structurally configured, in a manner so as to allow a human user to purposefully disassemble portions of or all of the animal-proof canister by uninterlocking at least one interlocking segmented portion or all of the interlocking segmented portions, to insert or access contents within the interior volume of the animal-proof canister or to fully disassemble the animal-proof canister, once the contents of the interior volume are removed, and position each of the plurality of interlocking portions into a nested more compact stacked arrangement, thereby facilitating efficient storage and transport when the animal-proof canister is in a collapsed configuration, and in a manner so as to substantially prevent a non-human animal from disassembling all or a portion of the animal-proof canister and accessing contents containable therein.

### BRIEF DESCRIPTION OF THE DRAWINGS

Some embodiments of this invention will be described in detail, with reference to the following figures, wherein like designations denote like members, wherein:

FIG. 1 is a semi-exploded perspective view of an embodiment of a collapsible animal-proof canister in a fully disassembled, semi-collapsed non-completed configuration, in accordance with the present invention;

FIG. 2 is a perspective view of an embodiment of a collapsible animal-proof canister in a partially assembled configuration, in accordance with the present invention;

FIG. 3 is a perspective view of an embodiment of a collapsible animal-proof canister in a fully assembled, completely non-collapsed configuration, in accordance with the present invention;

FIG. 4 is a perspective view of an embodiment of a separably joinable segmented body in a second non-collapsed body configuration, in accordance with the present invention;

FIG. 5 is a perspective view of an embodiment of a separably joinable interlocking segmented lid in a second non-collapsed lid configuration, in accordance with the present invention;

FIG. 6 is a perspective view of an embodiment of an interlocking separable segmented body portion, in accordance with the present invention;

FIG. 7 is a perspective view of an embodiment of a separably joinable interlocking segmented lid portion, in accordance with the present invention;

FIG. 8 is an exploded top view of an embodiment of a disassembled separably joinable interlocking segmented lid, in accordance with the present invention;

FIG. 9 is a perspective view of an embodiment of a collapsible animal-proof canister in a fully disassembled, completely collapsed nested and stacked configuration, in accordance with the present invention;

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

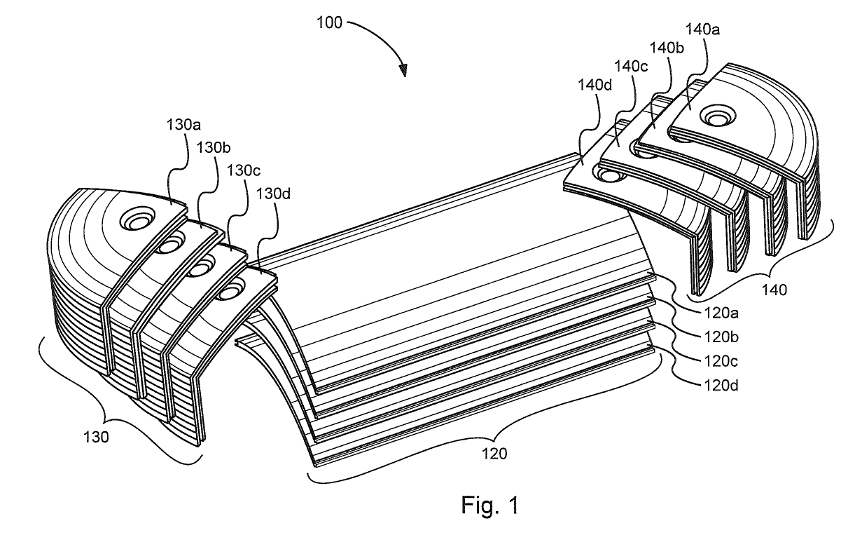

Referring to the drawings, FIG. 1 depicts a semi-exploded perspective view of an embodiment of a collapsible animal-proof canister 100 in a fully disassembled, semi-collapsed non-completed canister configuration. Embodiments of a collapsible animal-proof canister 100 may include a separably joinable segmented body 120. Moreover, embodiments of a separably joinable segmented body 120 may include a plurality of separable segmented body portions 120a-d. Furthermore, embodiments of a separably joinable segmented body portion, such as any of body portions 120a-d, may include structures allowing the body portion(s) 120a-d to be interlocked with other separably joinable segmented body portions, such as any of body portions 120a-d, as will be explained in further detail herein below. As further depicted in FIG. 1, the embodied separable segmented body portions 120a-d of the embodied separably joinable segmented body 120 are shown in a semi-exploded, not fully collapsed condition, having some nesting and stacking structural and functional characteristics.

Embodiments of a collapsible animal-proof canister 100 may also include at least one separably joinable lid, such as the separably joinable lid 130 or the separably joinable lid 140 shown in FIG. 1. As depicted, embodiments of a separably joinable lid may include a plurality of separable segmented lid portions, such as separable lid portions 130a-d of separably joinable lid 130 or separable lid portions 140a-d of separably joinable lid 140. Additionally, embodiments of the separable lid portions, such as separable lid portions 130a-d or 140a-d, may include structures allowing the separable lid portions 130a-d or 140a-d to be correspondingly interlocked with one another, to inter alia, form a consolidated separably joinable lid, such as lid 130 or lid 140, as will also be explained in further detail herein below. Also illustrated in FIG. 1, is a collapsible canister component configuration wherein the embodied separable lid portions 130a-d and 140a-d of the correspondingly respective embodied separably joinable lids 130 or 140 are shown in a semi-exploded, not fully collapsed condition, having some nesting and stacking structural and functional characteristics.

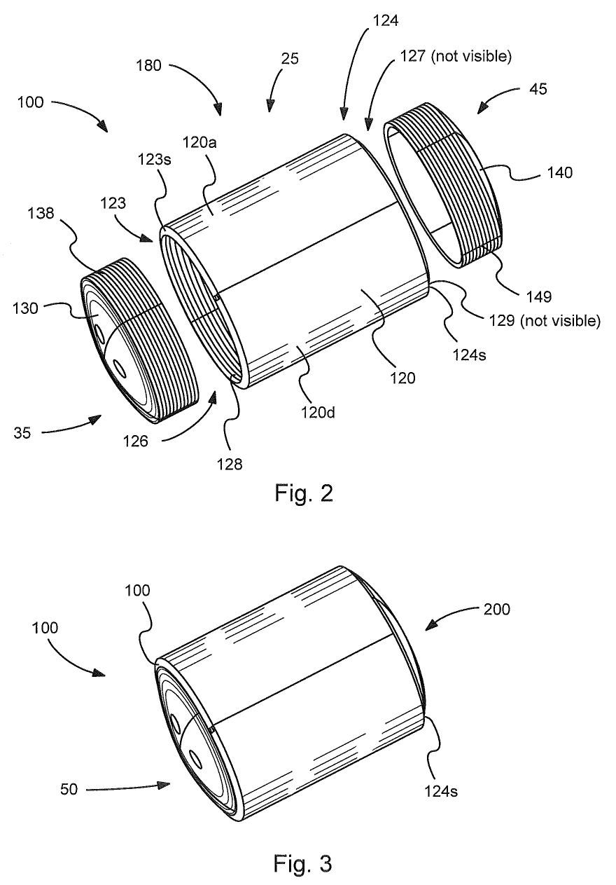

Design considerations pertaining to embodiments of the collapsible animal proof canister 100 may be aimed at providing a container that is both animal-proof and is collapsible. Accordingly, embodiments of the collapsible animal-proof canister 100 may include a plurality of separate and separable interlocking segmented portions, such as separate interlocking segmented portions 120a-d, 130a-d, and 140a-d shown in FIG. 1, or such as separate interlocking segmented portions 120, 130, and 140 shown in FIG. 2., wherein each of the plurality of interlocking segmented portions 120, 120a-d, 130, 130a-d, 140, and/or 140a-d is structurally configured so that, when the plurality of interlocking segmented portions 120, 120a-d, 130, 130a-d, 140, and/or 140a-d is fully structurally assembled and completely interlocked, (thereby forming a fully assembled, completed and non-collapsed animal proof canister 100 as depicted in FIG. 3), each of the plurality of interlocking segmented portions 120, 120a-d, 130, 130a-d, 140, and/or 140a-d is correspondingly interlocked to at least two other interlocking segmented portions of the plurality of interlocking portions 120, 120a-d, 130, 130a-d, 140, and/or 140a-d, in a manner such that the completely interlocked and fully assembled structural organization of interlocking segmented portions constitutes an animal-proof container 100 having a sealed interior volume 200, said interior volume 200 manifest inherently between the operable combination of the structures jointly illustrated in FIGS. 2 and 3, and referenced, accordingly in FIG. 3. The interior volume 200 of the completed non-collapsed animal-proof canister 100 may be readily accessible by humans through disconnection and removal of a separably joinable lid 130 and/or 140, but inaccessible to non-human animals because of the material strength and structural dimension of the completed non-collapsed canister configuration 50 of the separably joined and completed non-collapsed canister 100, and the inability of non-human animals to disconnect the at least one separately joinable lid 130 and/or 140 from the separably joinable segmented body 120. The structural dimension of animal-proof canister embodiments, such as animal-proof canister 100, may be sized so as to prevent non-human animals from successfully gripping the canister 100 in any manner (such as in a mouth, with teeth, with paws, with claws, with talons etc.) to exert any undesirable force to the canister 100 that would in any way undesirably manipulate the canister 100 to render access to contents possibly stored therein. For example, the structural dimension of the separably joinable segmented body 120 of an embodiment of an animal-proof canister 100 may prevent animals from gripping, biting, clenching, or in other ways firmly engaging the body 100.

With further reference to the drawings, FIG. 2 depicts a perspective view of an embodiment of a collapsible animal-proof canister 100 in one particularly illustrated embodiment of a partially assembled configuration 180. While existent in such a partially assembled configuration 180 embodiment, a collapsible animal-proof canister 100 may include three primary structural component parts, which primary structural component parts may be comprised of various sub-parts such as separably joinable interlocking member portions formed into assembled sub-part combinations and accordingly existent in three non-collapsed primary structural configurations, such three primary structural configurations possibly comprising: a separably joinable segmented body 120; a separably joinable lid 130; and a separably joinable lid 140. Those in the art should appreciate that any permutable number of separable primary sub-part component structure configurations may be combined to comprise an embodiment of a collapsible animal canister 100. With respect to the specific three-primary-sub-part structural configuration embodiment 180 depicted in FIG. 2, the three primary sub-parts 120, 130, and 140 may be combined in complimentary assembly to constitute a fully assembled, completed and non-collapsed animal-proof canister configuration 50 rendering an embodiment of a sealed and fully assembled collapsible animal-proof canister 100 having an interior volume 200, as accordingly depicted as a singular canister unit in FIG. 3. Each of the three primary sub-parts is shown existent in a potentially embodied non-collapsed distinct component configuration. For example, the separably joinable segmented body 120 primary sub-part configuration is depicted in a second non-collapsed body configuration 25, while each of the separably joinable lid (130 and 140) primary sub-part configurations is depicted in a second non-collapsed lid configuration (35 and 45 respectively). Moreover, each of the separably joinable lids 130 and/or 140 may be configured to separably and securely connect to the separably joinable segmented body 120, as discussed in greater detail below.

In addition, portions of the animal-proof canister 100 may be assembled as a group. For example, the separably joinable lid 140 may be securely connected to the separably joinable segmented body 120, thereby constituting a respective group of separably joined component parts 120 (comprising 120a-d) and 140 (comprising 140a-d) and rendering a partially-formed animal-proof canister group piece ( the canister group piece itself comprising the distinct assembled lid portion 140 being assembled and connected to the distinct assembled body portion 120), the partially-formed animal-proof canister component group piece having an opening 126 formed by at least two interlocked interlocking segmented portions, such as any respective corresponding interlocking separable segmented body portions, such segmented body portions in the present embodiment being comprised of the interlocking separable segmented body portions 120a-d. The opening 126 may constitute an aperture penetrating into an interior volume 200 of the partially-formed animal-proof canister group piece. Conversely, the grouped partially-formed and not fully assembled animal proof canister component sub-part pieces may be re-ordered and/or reversed in group assembly order. For example, the group assembly piece may comprise the separably joinable segmented body 120 being connected to the separably joinable lid 130, thereby rendering a partially assembled group canister structure having an opening 127 (not visible but inherently manifest and appropriately so referenced on FIG. 2).

To securely cover, close, or otherwise seal off either of the plurality of embodied openings 126 or 127 extending into the respective first or second ends 123 or 124 of the separably joinable segmented body 120, interlocking structural fastener features may be employed. For example, each of the ends 123 and/or 124 may be internally threaded, as referenced by respective features 128 and 129. Correspondingly, either or both of the separably joinable lids 130 and/or 140 may respectively include complimentary external threaded portions 138 and/or 149. Hence, the lids 130 and/or 140 may be screwed in or otherwise threadably inserted into the respective openings 126 and 127, such openings 126 and 127 having respective threads 128 and 129, the threaded structural interaction thereby interlocking the component sub-part features and securely forming a completed non-collapsed canister configuration 50 in a manner forming a separably joined and completed non-collapsed, yet collapsible, animal-proof canister 100 having an interior volume 200, as depicted in FIG. 3. Embodiments of a collapsible animal-proof canister 100, may therefore include a plurality of separably joinable lids, such as lids 130 and 140, wherein each of the separably joinable lids 130 and 140 may operably correspond to an opening 126 and 127 of the plurality of openings of the second non-collapsed body configuration 25 of the separably joinable segmented body 120.

Notably, embodiments of a collapsible animal-proof canister 100 may be configured so that the entire extremity of the completed non-collapsed canister configuration 50 may be substantially smooth, or otherwise be significantly devoid of sharply distinguishable protruding or intruding surface features. For instance, the embodied edges 123s and 124s of respective ends 123 and 124 of each of the segmented portions 120a-d (see FIG. 1) of the separably joinable segmented body 120 may be rounded, curve-chamfered, or smoothed so that the corresponding interface between the various respective joinable components, such as the segmented body 120 and a complimentary lid 130 and/or 140 does not yield sharp or obtrusive surface features that may be undesirably engaged by a non-human animal. However, it should also be understood that surface features that are not significantly engageable by non-human animals, but that are engageable by humans may be included on the various component parts of the animal-proof canister 100. For example, a feature such as a small key hole may be included in a lid, such as separably joinable segmented lid 130 and/or 140, and a human user may use a key or other implement to interface with the key hole and assist in removing the lid from covering an opening, such as opening 126 or 127, from the animal-proof canister 100. Such a feature may be fashioned in a way that prevents engagement and manipulation by non-human animals and renders the extremity of the animal-proof canister 100 substantially smooth.

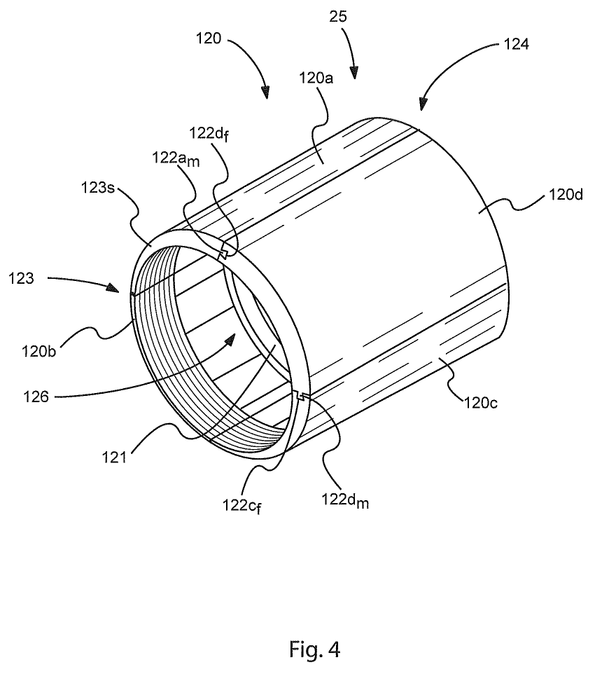

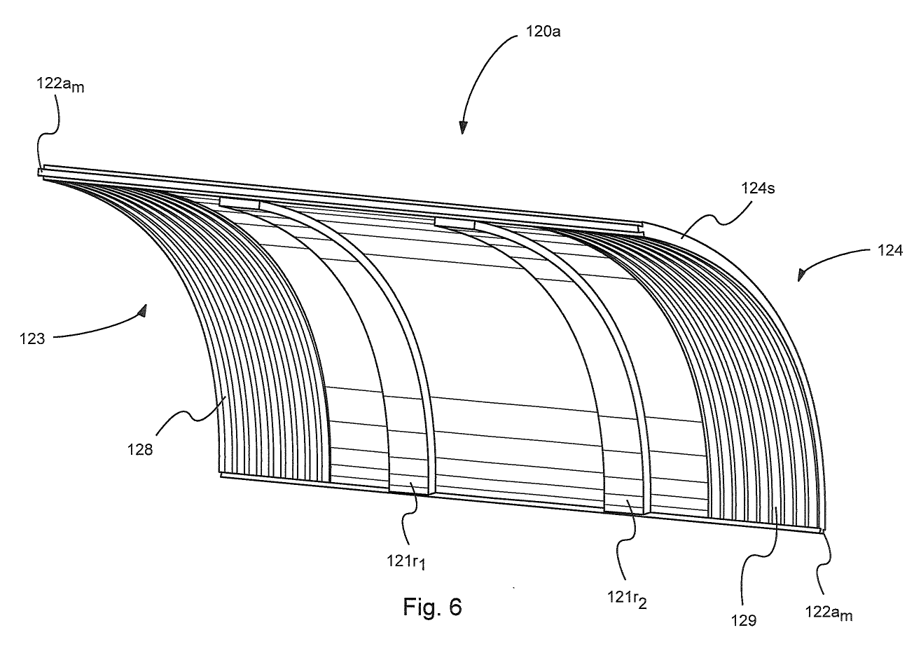

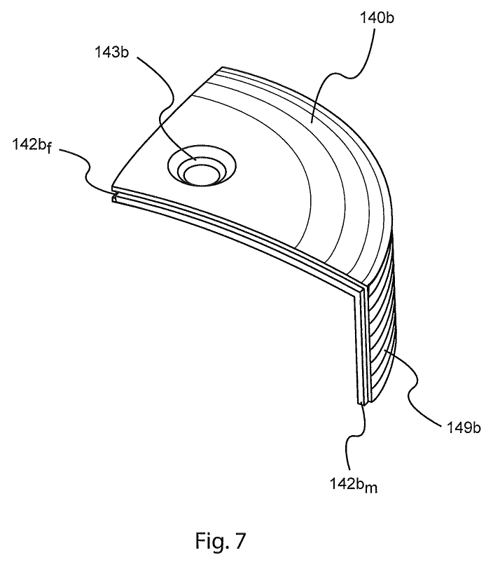

Turning further to the drawings, FIGS. 4 and 6 depict perspective views of respective embodiments of a separably joinable segmented body 120 in a second non-collapsed body configuration 25 and a separated individual interlocking separable segmented body portion 120a. When embodiments of a separably joinable segmented body 120 are assembled in a second non-collapsed body configuration 25, the separably joinable segmented body 120 may comprise a plurality of separably interlocked segmented body portions, such as the interlocked separable segmented body portions 120a, 120b, 120c, and 120d. The separable segmented body portions 120a-d may be formed so that when all of the plurality of individual body portions 120a-d are interlocked together, the grouped components may constitute an assembled separably joinable segmented body 120 fashioned in a second non-collapsed body configuration 25. Additionally, the separable body portions 120a-b may each be separated from other operably correlative separable body portions 120a-b, so that the separated body portions become uninterlocked, and so that the geometry of the separably joinable segmented body 120 may be collapsed and made smaller taking up less volume, as shown in FIG. 1 and also as discussed further herein, inter alia, with respect to FIG. 9.

Physically interlocking the various separable body portions 120a-d may be accomplished via various means. For example, each of the interlocking separable body portions 120a-d may include interlocking body portion members, such as the male interlocking members 122aₘ included on the individual separable body portion 120a shown in FIG. 6, or such as the male interlocking portions 122aₘ and 122dₘ being respectively interlocked with corresponding female interlocking portions 122d_{f} and 122c_{f} being respectively included on the interlocking separable body portions 120a, 120d, and 120c, which grouped and assembled along with separable body portion 120b, jointly form a separably joinable segmented body 120 fashioned in a second non-collapsed body configuration 25. When the various separable body portions, such as body portions 120a-d, are separably interlocked, the edges 123s and 124s (edge 124s not being visible in FIG. 4) may remain substantially smooth. The male and female interlocking members 122ₘ and 122_{f} may be shaped so that the members 122ₘ and 122_{f} may only be interlocked in an axially linear manner, by sliding separate members in opposite axial directions thereby pulling the male interlocking members 122ₘ into engagement with the female interlocking members 122_{f}. However, other design shapes may be employed having no radial structural blocking characteristics, thereby allowing the male and female interlocking members 122ₘ and 122_{f} to be both axially and radially moved with respect to one another. The shape of the interlocking members 122ₘ and 122_{f} may alter how the separable body portions 120a-d are interlocked together to form an assembled separably joinable segmented body 120. In addition, each of the ends 123 and/or 124 may be internally threaded, as referenced by respective features 128 and 129.

As depicted in FIG. 6, certain interlocking separable body portions, such as separable body portion 120a, may include multiple male interlocking members 122ₘ. Moreover, it should be appreciated that other interlocking separable body portions may include no male interlocking members 122ₘ, but only include female interlocking members 122_{f}. In addition, as depicted in FIG. 4, interlocking separable body portions, such as separable body portion 120d, may include both a male interlocking member 122ₘ and a female interlocking member 122_{f}. Those in the art should recognize that the various interlocking members 122ₘ and/or 122_{f} may be included on separable interlocking body portions 120a-d in any manner that facilitates secure assembly of the body portions 120a-d into a grouped segmented structure existent in non-collapsed configuration, such as a second non-collapsed body configuration 25. Each separable segmented body portion embodiment of the plurality of separable segmented body portions 120a-b of embodiments of the separably joinable segmented body 120 may include an interlocking member 122. Each interlocking member 122 may be configured to securely interlock to a separate corresponding interlocking member 122 of a separate corresponding separable segmented body portion of the separably joinable segmented body 120, such that when the separably joinable segmented body is positioned in the second non-collapsed body configuration 25 all of the interlocking members 122 of all of the separable segmented body portions 120a-d are interlocked together rendering a completely interlocked separably joinable segmented body 120.

Each embodiment of a separable segmented body portion of the plurality of separable segmented body portions 120a-d of embodiments of the separably joinable segmented body 120 may include an internal rib member 121r. Each internal rib member 121r may be configured to align with a separate corresponding internal rib member 121r of a separate corresponding separable segmented body portion of the separably joinable segmented body 120, such that when the separably joinable segmented body 120 is positioned in the second non-collapsed body configuration 25 all of the internal rib members 121r of all of the separable segmented body portions 120a-d are structurally aligned to form a singular substantially completed conglomerate rib member 121 corresponding to the entire separably joinable segmented body 120. As depicted in FIG. 6, embodiments of interlocking separable segmented body portions 120, such as body portion 120a, may include multiple internal rib members, such as internal rib members 121r₁ and 121r₂. Moreover, it should be appreciated that the multiple internal rib members, such as internal rib members 121r₁ and 121r₂, may be configured to align with multiple separate corresponding internal rib members of separate corresponding separable segmented body portions of the separably joinable segmented body 120, such that when the separably joinable segmented body 120 is positioned in the second non-collapsed body configuration 25 all of the multiple internal rib members, such as 121r₁ and 121r₂, of all of the separable segmented body portions 120a-d are structurally aligned to form multiple substantially completed conglomerate rib members 121 corresponding to the entire separably joinable segmented body 120.

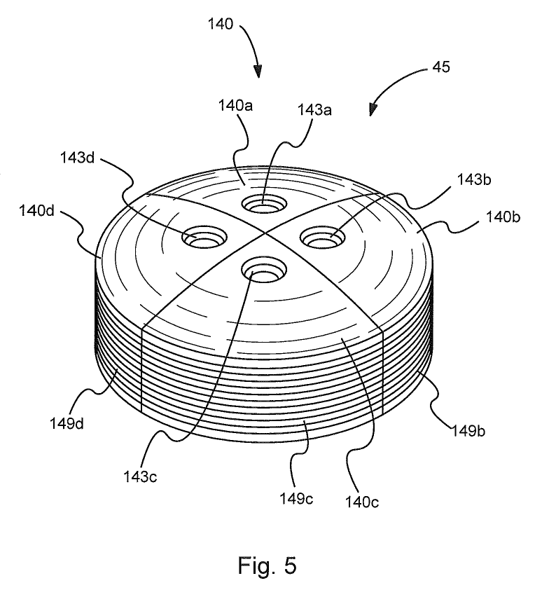

With continued reference to the drawings, FIGS. 5 and 7 depict perspective views of respective embodiments of a separably joinable segmented lid 140 in a second non-collapsed lid configuration 45 and a separated individual interlocking separable segmented lid portion 140b. When embodiments of a separably joinable segmented lid 140 are assembled in a second non-collapsed lid configuration 45, the separably joinable segmented lid 140 may comprise a plurality of separably interlocked segmented lid portions, such as the interlocked separable segmented lid portions 140a, 140b, 140c, and 140d. The separable segmented lid portions 140a-d may be formed so that when all of the plurality of individual lid portions 140a-d are interlocked together, the grouped components may constitute an assembled separably joinable segmented lid 140 fashioned in a second non-collapsed lid configuration 45. Additionally, the separable lid portions 140a-b may each be separated from other operably correlative separable lid portions 140a-b, so that the separated lid portions may become uninterlocked, and so that the geometry of the separably joinable segmented lid 140 may be collapsed and made smaller taking up less volume, as shown in FIG. 1 and also as discussed further herein, inter alia, with respect to FIG. 9.

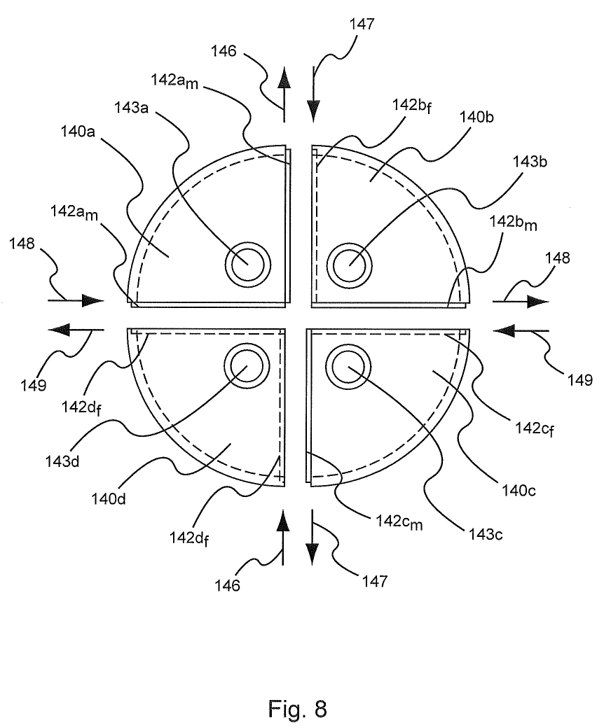

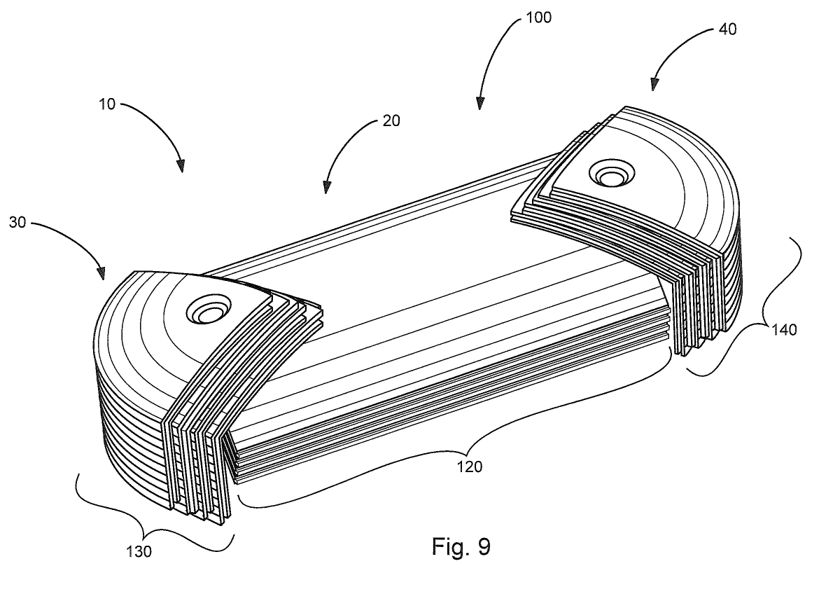

Physically interlocking various embodiments of separable lid portions, such as separable lid portions 140a-d of an embodiment of a separably joinable segmented lid, such as the fully assembled separably joinable segmented lid 140 shown in FIG. 5, may be accomplished via various means. For example, as depicted in FIG. 8, each of the interlocking separable lid portions 140a-d may include interlocking male and/or female lid members 142, such as female interlocking lid members 142_{f} (which are not visible but are shown as hidden with dashed lines), or such as the male interlocking lid members 142ₘ. When the various separable lid portions, such as lid portions 140a-d, are separably interlocked, the entire surface of the resultant fully assembled separably joinable segmented lid 140 may remain substantially smooth, so that when operably joined with other components to form an animal-proof canister 100, the canister may be significantly devoid of sharply distinguishable protruding or intruding surface features.

As depicted in FIG. 8, embodiments of interlocking separable lid portions, such as separable lid portion 140a, may include multiple male interlocking lid members 142aₘ. Moreover, it should be appreciated that other interlocking separable lid portion embodiments may include no male interlocking lid members, but only include female interlocking lid members, such as separable lid portion 140d having multiple female interlocking lid members 142d_{f}. In addition, interlocking separable segmented lid portions, such as separable lid portions 140b and 140c, may include both male and female interlocking lid members, such as respective interlocking lid members 142bₘ and 142b_{f} and also interlocking lid members 142cₘ and 142c_{f}. Those in the art should recognize that the various interlocking lid members 142ₘ and/or 142_{f} may be included on separable interlocking lid portions 140a-d in any manner that facilitates secure assembly of the lid portions 140a-d into a grouped segmented structure existent in non-collapsed configuration, such as a second non-collapsed lid configuration 45. Each separable segmented lid portion embodiment of the plurality of separable segmented lid portions 140a-b of embodiments of the separably joinable segmented lid 140, or such as separably joinable segmented lid 130, may include an interlocking member 142. Each interlocking member 142 may be configured to securely interlock to a separate corresponding interlocking member 142 of a separate corresponding separable segmented lid portion of the separably joinable segmented lid 140, such that when the separably joinable segmented lid is positioned in a second non-collapsed lid configuration 45 all of the interlocking members 142 of all of the separable segmented lid portions 140a-d are interlocked together rendering a completely interlocked separably joinable segmented lid 140.

The male and female interlocking lid members 142ₘ and 142_{f} may be shaped so that the interlocking lid members 142ₘ and 142_{f} may only be interlocked in a linear translational manner, by sliding separate members in opposite translational directions thereby pulling the male interlocking members 142ₘ into engagement with the female interlocking members 142_{f}. For example, with respect to the embodiment of an unassembled separably joinable segmented lid 140 depicted in FIG. 8, the various interlocking lid members 142 of the various separable lid portions 140a-d may be put together in the following manner: separable lid portion 140a may be joined and interlocked with separable lid portion 140b by aligning the corresponding respective interlocking members 142aₘ and 142b_{f} and then linearly sliding the separable lid portion 140a in a direction 146 and linearly sliding the separable lid portion 140b in a direction 147 to interlock the component parts together to form one half of the segmented lid 140 comprising joined portions 140a and 140b; separable lid portion 140c may be joined and interlocked with separable lid portion 140d by aligning the corresponding respective interlocking members 142cₘ and 142d_{f} and then linearly sliding the separable lid portion 140d in a direction 146 and linearly sliding the separable lid portion 140c in a direction 147 to interlock the component parts together to form another half of the segmented lid 140, the other half comprising joined portions 140c and 140d; and then aligning the respective interlocking lid members of the two formed lid halves and sliding the lid halve composed of separable portions 140a-b in a direction 148 and sliding the lid halve composed of separable portions 140c-d in a direction 149 to interlock and fully assemble the separable segmented portions 140a-d into a completed separably joinable segmented lid 140 existent in a second non-collapsed configuration 45, as depicted in FIG. 5. While a particular assembly protocol of a particular interlocking lid 140 embodiment has been described, those in the art should appreciate that other interlocking lid member 142 design shapes and positions may be employed that may alter how the separable lid portions 140a-d are interlocked together to form an assembled separably joinable segmented lid 140. In addition, separably joinable segmented lid embodiments, such as lids 130 and 140, may be externally threaded, as referenced by respective features 138 and 139, shown in FIG. 2. Additionally, each separate interlocking lid portion 140a-d may include threaded exterior surfaces that match-up and align with threaded surfaces of corresponding lid portions 140a-d so that when the lid portions 140a-d are fully assembled together the resultant separably joinable segmented lid 140 includes a completed threaded external surface, which may facilitate operable secure engagement with a separably joinable segmented body 120 to form a completed animal-proof canister 100. Notably, animal-proof canister 100 embodiments having coverings or lids, such as lids 130 and/or 140, that operably connect to corresponding openings, such as openings 126 and/or 127 of an embodiment of a separably joinable segmented body 120, may utilize the connection between the lid(s) 130, 140 with the body 120 to strengthen the overall canister 100 structure. For example, the external threads 138 and 149, when threadably interlocked with the corresponding respective internal threads 128 and 129 of openings 126 and 127, help to add structural support to the separably joined body 120 of the animal-proof canister 100, thereby rendering the entire canister 100 structurally stronger when oriented in an assembled second non-collapsed configuration 50, as depicted in FIG. 3.

As further depicted in FIGS. 5 and 7-8, embodiments of a separably joinable lid may include subtle and smooth human engagement features 143. The subtle and smooth human engagement features 143 may be positioned on the extremity of the lid 140, such as the dimpled subtle and smooth human engagement features 143a-d. The subtle and smooth human engagement features 143 may be configured to help facilitate operable connection and disconnection of the separably joinable lid 140 from the corresponding opening 129 (not visible, but referenced in FIG. 2) of the separably joinable segmented body 120, when the separably joinable segmented body 120 is in the second non-collapsed body configuration 25, through purposefully skillful physical human motive engagement with the human engagement features 143 of the separably joinable lid 140, and further wherein the subtle and smooth human engagement features 143 are configured so as to be non-obtrusive and substantially non-operably engageable by non-human animals. The subtle and smooth human engagement features 143 may be formed in a manner so as to operably facilitate an opening up and purposefully partial disassembly of the animal-proof container 100 having an interior volume 200 (see FIGS. 2-3), so that a human user can access the interior volume 200, and so that a non-human animal can not operably facilitate the opening up and purposefully partial disassembly of the container 100 having an interior 200, in a manner that the container 100 remains sealed and the interior volume 200 is operably inaccessible to a non-human animal.

Turning again to the drawings, FIG. 9 depicts a perspective view of an embodiment of a collapsible animal-proof canister 100 in a fully disassembled, completely collapsed nested and stacked configuration 10. When oriented in a completely collapsed nested and stacked configuration 10, the animal-proof canister 100 may take up substantially less volume and space as when the animal-proof canister is in a second non-collapsed configuration 50, as depicted in FIG. 3. This may allow a human user to disassemble the animal-proof canister, collapse it, and then store it and/or transport it in a convenient reduced-volume configuration 10. Embodiments of animal-proof canisters 100 having a separably joinable segmented body 120 may include a first collapsed body configuration 20, wherein each of the individual body portions 120a-d (see FIG. 1) may be shaped so as to be nested and stacked one with another in a more compact collapsed body arrangement. Moreover, embodiments of animal-proof canisters 100 having a separably joinable segmented lid(s) 130 and/or 140 may include first collapsed lid configurations 30 and/or 40, wherein each of the individual lid portions 130a-d and/or 140a-d of the various lids 130 and/or 140 (see FIG. 1) may be shaped so as to be nested and stacked one with another into more compact collapsed lid arrangements.

With reference to FIGS. 1-9, an embodiment of a method of preventing animals from retrieving contents from a collapsible canister is described. The method of preventing animals from retrieving contents from a collapsible canister may comprise providing an animal-proof canister 100. The animal-proof canister may include a plurality of interlocking segmented portions 120a-b, 130a-b, 140a-b, wherein each of the plurality of interlocking segmented portions 120a-b, 130a-b, 140a-b is structurally configured so that, when the plurality of interlocking segmented portions 120a-b, 130a-b, 140a-b is fully disassembled and non-interlocked, each of the plurality of interlocking segmented portions 120a-b, 130a-b, 140a-b is positionable in a stacked arrangement, so that each of the plurality of interlocking segmented portions 120a-b, 130a-b, and 140a-b resides in a nested more compact arrangement with respect to at least one other interlocking segmented portion of the plurality of various interlocking segmented portions 120a-b, 130a-b, 140a-b. Another methodological step for preventing animals from accessing contained contents may be to assemble a group of the plurality of interlocking segmented portions such as the separable segmented body portions 120a-d and also the separable segmented lid portions 140a-d, by interlocking each interlocking segmented portion, such as the separably joinable segmented body 120 (comprising segmented body portions 120a-d) and the separably joinable segmented lid 140 (comprising segmented lid portions 140a-d), of the group of the plurality of interlocking segmented portions (separable segmented body portions 120a-d and also the separable segmented lid portions 140a-d) to partially form an animal-proof canister 100, the partially-formed animal-proof canister 100 having an opening, such as opening 126, formed by at least two interlocked interlocking segmented portions, such as interlocking separable segmented body portions 120a-d, the opening 126 constituting an aperture into an interior volume 200 of the partially-formed animal-proof canister 100. Once various sub-parts, such as the body 120 and the lid 140 of the animal-proof canister 100, are grouped and partially formed so as to provide and opening, such as opening 126, into a canister structure having an interior volume 200, then contents may be inserted through the opening and into the interior volume 200 of the partially-formed animal-proof canister 100.

With contents stowed, additional animal-proofing methodology may include fully assembling and completely forming the animal-proof canister 100 by interlocking at least one other interlocking segmented portion, such as the separably joinable segmented lid 130, to the at least two interlocked interlocking segmented portions, such as segmented body portions 120a-d, forming the opening, such as opening 126, of the partially-formed animal-proof canister 100, thereby closing the aperture and sealing the contents into the interior volume 200 of the fully assembled and completely formed animal-proof canister 100.

When the animal-proof canister 100 is fully assembled into a second non-collapsed configuration 50 with contents stored therein, the animal-proof canister 100 may be structurally configured, in a manner so as to allow a human user to purposefully disassemble portions of or all of the animal-proof canister 100 by uninterlocking at least one interlocking segmented portion, such as either or both lids 130 and/or 140, or all of the interlocking segmented portions, such as segmented portions 120a-b, 130a-b, 140a-b, to insert new contents or access previously inserted contents contained within the interior volume 200 of the animal-proof canister 100 or to fully disassemble the animal-proof canister 100, once the contents of the interior volume 200 are removed, and position each of the plurality of interlocking portions, such as portions 120a-b, 130a-b, 140a-b, into a nested more compact stacked arrangement, thereby facilitating efficient storage and transport when the animal-proof canister 100 is in a collapsed configuration, such as the collapsed arrangement depicted in FIG. 9, and in a manner so as to substantially prevent a non-human animal from disassembling all or a portion of the animal-proof canister 100 and from accessing any contents containable therein.

As embodiments of animal-proof canisters 100 may be utilized by hikers and campers or others who may desire to pack and transport the canisters 100, those in the art should recognize that animal-proof canister embodiments may be comprised of lightweight materials that still render structural strength according to the desirable dimensions of the animal-proof canister embodiments. For example, all or some of the various components of an animal-proof canister 100 may be formed of lightweight, yet strong, metals or metal alloys, plastics or other polymeric materials, composite materials, or any other material that may yield sufficient structural strength while also minimizing the weight of the canister 100. Moreover, animal-proof canister embodiments 100 may be significantly air-tight, in order to help prevent escape of odors associated with contents that may be housed within the animal-proof canister 100. For instance, gaskets, washers, seals, O-rings, or other implements may be incorporated into canister 100 designs to help facilitate odor containment. Additionally, the interlocking members, such as member 122 and/or 142 and other like members, of the various segmented portions, such as portions 120a-d, 130a-d, and 140a-d of the animal-proof canister, may be comprised of material to help seal the canister 100, or may otherwise be configured to seal the canister 100 when assembled into a non-collapsed configuration 50. Likewise, animal-proof canister embodiments 100 may be significantly water-resistant, in order to keep contents contained therein dry and also to allow the canisters 100 to float when encountering a body of liquid. Similar physical structures or operable functions may be employed to render water resistance as also may employed to render odor resistance.

To help facilitate animal-proofing, those in the art should appreciate that the materials utilized to form the various components that may comprise an animal-proof canister 100 may be significantly shatter-resistant. For example, canister embodiments should be able to withstand dropping, pushing, shoving, kicking, hitting, scraping, biting, rolling, smacking, or other actions that may be inflicted on the canister 100 by either humans or non-human animals. In addition, the combination of material strength and structural dimension of embodiments of animal-proof canisters should be sufficient to withstand impact forces and other forces applied to the canister by either humans or non-human animals. For instance, canister embodiments 100, when in a non-collapsed configuration, such as configuration 50, should be able to withstand the weight of a bear standing on it, biting it, sitting on it, clawing at it, or otherwise physically engaging the canister.

To facilitate ready identification and/or location of animal-proof canisters, those in the art will understand that embodiments of animal-proof canisters 100 may be formed of, coated, or fashioned with reflective materials that may be easily seen when bombarded by light, such as the light of a flashlight at night. Hence, a human user having a light, may shine the light upon the canister and readily identify the canister, but a non-human animal being unable to operate a light, could not take advantage of any reflective features.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention.

What is claimed is:

1. An animal-proof canister comprising:
a separably joinable segmented body, the separably joinable segmented body having:
a first collapsed body configuration, wherein a plurality of separable segmented body portions of the separably joinable body are not joined together being separately positioned in a nested compact stacked body arrangement, and
a second non-collapsed body configuration, wherein all separably joinable segmented body portions of the separably joinable segmented body are separably joined together, such that when positioned in a second non-collapsed configuration the separably joinable segmented body has at least one opening; and
at least one separably joinable lid, the at least one separably joinable lid configured to separably and securely connect to the separably joinable segmented body rendering a completed non-collapsed canister configuration in a manner forming a separably joined and completed non-collapsed canister having an interior volume, the interior volume of the completed non-collapsed canister being readily accessible by humans through disconnection and removal of the at least one separably joinable lid, but inaccessible to non-human animals because of the material strength and structural dimension of the completed non-collapsed canister configuration of the separably joined and completed non-collapsed canister, and the inability of non-human animals to disconnect the at least one separately joinable lid from the separably joinable segmented body.

2. The animal-proof canister of claim 1, wherein the at least one separably joinable lid is segmented having:
a first collapsed lid configuration, wherein a plurality of separable segmented lid portions of the at least one separably joinable lid are not joined together being separately positioned in a nested compact stacked lid arrangement, and
a second non-collapsed lid configuration, wherein all separably joinable segmented lid portions of the at least one separably joinable lid are separably joined together, such that when positioned in the second non-collapsed lid configuration the at least one separably joinable lid is positioned in a completed non-collapsed lid configuration corresponding to operable structural connection with the least one opening.

3. The animal-proof canister of claim 1, wherein the second non-collapsed body configuration includes a plurality of openings.

4. The animal-proof canister of claim 3, further comprising a plurality of separably joinable lids, wherein each of the separably joinable lids operably corresponds to an opening of the plurality of openings of the second non-collapsed body configuration of the separably joinable segmented body.

5. The animal-proof canister of claim 1, wherein the entire extremity of the completed non-collapsed canister configuration is substantially smooth being significantly devoid of sharply distinguishable protruding or intruding surface features.

6. The animal-proof canister of claim 1, wherein the at least one separably joinable lid is threadably connected to the at least one opening of the separably joinable segmented body when the separably joinable segmented body is in the second non-collapsed body configuration.

7. The animal-proof canister of claim 1, wherein each separable segmented body portion of the plurality of separable segmented body portions of the separably joinable segmented body includes an interlocking member, each interlocking member being configured to securely interlock to a separate corresponding interlocking member of a separate corresponding separable segmented body portion of the separably joinable segmented body, such that when the separably joinable segmented body is positioned in the second non-collapsed body configuration all of the interlocking members of all of the separable segmented body portions are interlocked together rendering a completely interlocked separably joinable segmented body.

8. The animal-proof canister of claim 1, wherein each separable segmented body portion of the plurality of separable segmented body portions of the separably joinable segmented body includes an internal rib member, each internal rib member being configured to align with a separate corresponding internal rib member of a separate corresponding separable segmented body portion of the separably joinable segmented body, such that when the separably joinable segmented body is positioned in the second non-collapsed body configuration all of the internal rib members of all of the separable segmented body portions are structurally aligned to form a singular substantially completed conglomerate rib member corresponding to the entire separably joinable segmented body.

9. The animal-proof canister of claim 1, wherein the at least one separably joinable lid includes subtle and smooth human engagement features, the subtle and smooth human engagement features being positioned on the extremity of the lid and configured to help facilitate operable connection and disconnection of the at least one separably joinable lid from the at least one opening of the separably joinable segmented body, when the separably joinable segmented body is in the second non-collapsed body configuration, through purposefully skillful physical human motive engagement with the human engagement features of the at least one separably joinable lid, and further wherein the subtle and smooth human engagement features are configured so as to be non-obtrusive and substantially non-operably engageable by non-human animals.

10. A collapsible container for preventing animals from retrieving contents therefrom when the collapsible container is in a non-collapsed configuration, the collapsible container comprising:
a plurality of interlocking segmented portions, wherein each of the plurality of interlocking segmented portions is structurally configured so that, when the plurality of interlocking segmented portions is fully disassembled and non-interlocked, each of the plurality of interlocking segmented portions is positionable in a stacked arrangement, so that each of the plurality of interlocking segmented portions resides in a nested more compact arrangement with respect to at least one other interlocking segmented portion of the plurality of interlocking segmented portions;
wherein, when the plurality of interlocking segmented portions is fully structurally assembled and completely interlocked, each of the plurality of interlocking segmented portions is interlocked to at least two other interlocking segmented portions of the plurality of interlocking portions, in a manner such that the completely interlocked and fully assembled structural organization of interlocking segmented portions constitutes a container having a sealed interior volume; and
further wherein at least one of the interlocking segmented portions of the plurality of interlocking segmented portions is removably joinable to at least two other interlocking segmented portions of the plurality of interlocking segmented portions, in a manner so as to operably facilitate an opening up and purposefully partial disassembly of the container having an interior volume, so that a human user can access the interior volume, and so that a non-human animal can not operably facilitate the opening up and purposefully partial disassembly of the container having an interior, in a manner that the container remains sealed and the interior volume is operably inaccessible to a non-human animal.

11. The collapsible container of claim 10, wherein, when the plurality of interlocking segmented portions is fully structurally assembled and completely interlocked, the collapsible container is significantly air tight.

12. The collapsible container of claim 10, wherein, when the plurality of interlocking segmented portions is fully structurally assembled and completely interlocked, the collapsible container is significantly water-resistant.

13. The collapsible container of claim 10, wherein, when the plurality of interlocking segmented portions is fully structurally assembled and completely interlocked, the collapsible container is significantly shatter-resistant.

14. The collapsible container of claim 10, wherein the container is reflective.

15. A method of preventing animals from retrieving contents from a collapsible canister, the method comprising:
providing an animal-proof canister including:
a plurality of interlocking segmented portions, wherein each of the plurality of interlocking segmented portions is structurally configured so that, when the plurality of interlocking segmented portions is fully disassembled and non-interlocked, each of the plurality of interlocking segmented portions is positionable in a stacked arrangement, so that each of the plurality of interlocking segmented portions resides in a nested more compact arrangement with respect to at least one other interlocking segmented portion of the plurality of interlocking segmented portions;
assembling a group of the plurality of interlocking segmented portions, by interlocking each interlocking segmented portion of the group of the plurality of interlocking segmented portions to partially form an animal-proof canister, the partially-formed animal-proof canister having an opening formed by at least two interlocked interlocking segmented portions, the opening constituting an aperture into an interior volume of the partially-formed animal-proof canister;
inserting contents through the opening and into the interior volume of the partially-formed animal-proof canister; and
fully assembling and completely forming the animal-proof canister by interlocking at least one other interlocking segmented portion to the at least two interlocked interlocking segmented portions forming the opening of the partially-formed animal-proof canister, thereby closing the aperture and sealing the contents into the interior volume of the fully assembled and completely formed animal-proof canister;
wherein the animal-proof canister is structurally configured, in a manner so as to allow a human user to purposefully disassemble portions of or all of the animal-proof canister by uninterlocking at least one interlocking segmented portion or all of the interlocking segmented portions, to insert or access contents within the interior volume of the animal-proof canister or to fully disassemble the animal-proof canister, once the contents of the interior volume are removed, and position each of the plurality of interlocking portions into a nested more compact stacked arrangement, thereby facilitating efficient storage and transport when the animal-proof canister is in a collapsed configuration, and in a manner so as to substantially prevent a non-human animal from disassembling all or a portion of the animal-proof canister and accessing contents containable therein.

16. The method of preventing animals from retrieving contents from a collapsible canister of claim 15, wherein, when the contents are sealed into the interior volume of the fully assembled and completely formed animal-proof canister, the canister is significantly air-tight and water-resistant.

17. The method of preventing animals from retrieving contents from a collapsible canister of claim 15, wherein a human user engages subtle and smooth engagement features to purposefully uninterlock at least one interlocking segmented lid portion of the animal-proof canister.

18. The method of preventing animals from retrieving contents from a collapsible canister of claim 17, wherein the lid portion is threadably attached to the at least two other interlocking portions.

19. The method of preventing animals from retrieving contents from a collapsible canister of claim 18, wherein the threaded attachment of the lid to the at least two other interlocking portions adds structural strength to the collapsible canister.

20. The method of preventing animals from retrieving contents from a collapsible canister of claim 15, wherein the collapsible canister, when fully assembled, is significantly shatter-resistant having an extremity that is substantially smooth to prevent ready engagement and manipulation of the canister by non-human animals.
